(19) United States
(12) Patent Application Publication
(10) Pub. No.: US 2020/0382498 A1
(43) Pub. Date: Dec. 3, 2020

(54) METHOD AND DEVICE FOR PORTAL AUTHENTICATION

(71) Applicant: Hangzhou DPtech Technologies Co., Ltd., Zhejiang Province (CN)

(72) Inventor: Huihai HE, Zhejiang (CN)

(73) Assignee: Hangzhou DPtech Technologies Co., Ltd., Zhejiang Province (CN)

(21) Appl. No.: 16/884,510

(22) Filed: May 27, 2020

(30) Foreign Application Priority Data
May 28, 2019 (CN) 201910452806.7

(51) Int. Cl. H04L 29/06; H04L 29/08

(52) U.S. Cl. CPC H04L 63/0876; H04L 67/02; H04L 2463/121; H04L 63/06; H04L 63/123

(57) ABSTRACT

The present application provides a method and device for Portal authentication. The method includes: sending an authentication webpage to a user terminal in response to an authentication request from the user terminal; authenticating login information returned by the user terminal through the authentication webpage; in response to successful authentication with respect to the login information, sending online information corresponding to the user terminal to an authentication device, such that the authentication device updates an online state of the user terminal.

### CROSS REFERENCE TO RELATED APPLICATION

This application claims priority to Chinese Patent Application No. 201910452806.7 entitled “METHOD AND DEVICE FOR PORTAL AUTHENTICATION” and filed on May 28, 2019, the disclosure of which is incorporated herein by reference in its entirety.

### TECHNICAL FIELD

The present application relates to the field of network technology, and to a method and device for Portal authentication.

### BACKGROUND

Portal authentication is also commonly referred to as Web (webpage) authentication. For example, by receiving a user name and a password input through a Web page by a user and authenticating the user accordingly, a purpose for controlling user's access may be realized.

### SUMMARY

To improve flexibility of an authentication device and security of a system, the present application provides a method and a device for Portal authentication The Portal server authenticates login information returned by the user terminal through an authentication webpage in response to an authentication request from the user terminal, without authenticating login information of the user by the authentication device, thereby increasing flexibility of the authentication device.

To achieve the above-mentioned purposes, the present application provides the technical solutions as follows.

According to a first aspect of the present application, a method of Portal authentication is provided, the method being applied to a Portal server and comprises:

in response to an authentication request from a user terminal, sending an authentication webpage to the user terminal;

authenticating login information returned by the user terminal through the authentication webpage; and

in response to successful authentication with respect to the login information, sending online information corresponding to the user terminal to an authentication device, such that the authentication device updates an online state of the user terminal.

Alternatively, the method further comprises:

in response to the successful authentication with respect to the login information, signing the online information with a key shared by the Portal server and the authentication device to obtain signed information; and

sending the signed information to the authentication device, such that the authentication device verifies the online information.

Alternatively, the method further comprises:

in response to the successful authentication with respect to the login information, obtaining a creation timestamp of the online information; and

sending the creation timestamp to the authentication device, such that the authentication device verifies the online information based on time difference between a time of receiving the online information and the creation timestamp.

According to a second aspect of the present application, a method of Portal authentication is provided, the method being applied to an authentication device and comprises:

receiving a Hyper Text Transfer Protocol (HTTP) request from a user terminal;

in response to determining that the user terminal is not online, returning an address of an authentication webpage to the user terminal, such that the user terminal sends user login information to a Portal server by accessing the address; and

upon receiving, from the Portal server, online information indicating that the user login information is authenticated by the Portal server, marking the user terminal as online.

Alternatively, the method further comprises:

receiving signed information from the Portal server, wherein the signed information is obtained by signing the online information with a key shared by the Portal server and the authentication device;

signing the online information with the shared key to obtain signed verification information at the authentication device; and

in response to determining that the signed information is consistent with the signed verification information, determining that the online information is verified, wherein the marking of the user terminal as online comprises: marking the user terminal corresponding to the verified online information as online.

Alternatively, the signing of the online information with the shared key comprises: in response to determining that a timestamp in the online information is consistent with local time, signing the online information with the shared key.

Alternatively, the method further comprises:

receiving a creation timestamp of the online information from the Portal server;

in response to determining that time difference between a time of receiving the online information and the creation timestamp is less than a preset threshold, determining that the online information is verified, wherein the marking of the user terminal as online comprises: marking the user terminal corresponding to the verified online information as online.

According to a third aspect of the present application, a device of Portal authentication is provided, the device being applied to a Portal server and comprises:

an authentication webpage sending unit, configured to in response to an authentication request from a user terminal, send an authentication webpage to the user terminal;

a login information authentication unit, configured to authenticate login information returned by the user terminal through the authentication webpage; and

an online information sending unit, configured to in response to successful authentication with respect to the login information, send online information corresponding to the user terminal to an authentication device, such that the authentication device updates an online state of the user terminal.

Alternatively, the device further comprises:

an online information signing unit, configured to in response to the successful authentication with respect to the login information, sign the online information with a key shared by the Portal server and the authentication device to obtain signed information; and

a signed information sending unit, configured to send the signed information to the authentication device, such that the authentication device verifies the online information.

Alternatively, the device further comprises:

a time information obtaining unit, configured to in response to the successful authentication with respect to the login information, obtaining a creation timestamp of the online information;

a time information sending unit; configured to send the creation timestamp to the authentication device, such that the authentication device verifies the online information based on time difference between a time of receiving the online information and the creation timestamp.

According to a fourth aspect of the present application; a device of Portal authentication is provided, the device being applied to an authentication device and comprises:

a request receiving unit, configured to receive a Hyper Text Transfer Protocol (HTTP) request from a user terminal;

an address returning unit, configured to in response to determining that the user terminal is not online, return an address of an authentication webpage to the user terminal, such that the user terminal sends user login information to a Portal server by accessing the address;

an online information receiving unit, configured to receive online information from the Portal server, the online information indicating that the user login information is authenticated by the Portal server; and

an online state marking unit, configured to mark the user terminal as online.

Alternatively, the device further comprises:

a signed information receiving unit, configured to receive signed information from the Portal server, wherein the signed information is obtained by signing the online information with a key shared by the Portal server and the authentication device;

an online information verifying unit, configured to sign the online information with the shared key to obtain signed verification information at the authentication device; and

a verification result determining unit, configured to in response to determining that the signed information is consistent with the signed verification information, determine that the online information is verified, wherein the marking of the user terminal as online comprises: marking the user terminal corresponding to the verified online information as online.

Alternatively, the online information verifying unit, further configured to in response to determining that a timestamp in the online information is consistent with local time, sign the online information with the shared key.

Alternatively, the device further comprises:

a time information receiving unit, configured to receive a creation timestamp of the online information from the Portal server;

a time difference determining unit, configured to determine that time difference between a time of receiving the online information and the creation timestamp; and

a time difference verifying unit, configured to in response to that the time difference is less than a preset threshold, determine that the online information is verified, wherein the marking of the user terminal as online comprises: marking the user terminal corresponding to the verified online information as online.

According to a fiftieth aspect of the present application, a Portal server is provided, comprising:

a processor; and

a memory for storing instructions that are executable by the processor to perform operations comprising: in response to an authentication request from a user terminal, sending an authentication webpage to the user terminal; authenticating login information returned by the user terminal through the authentication webpage; and in response to successful authentication with respect to the login information, sending online information corresponding to the user terminal to an authentication device, such that the authentication device updates an online state of the user terminal.

According to a sixth aspect of the present application, a computer-readable storage medium having computer instructions stored thereon is provided, wherein the instructions are executed by a processor to implement steps of any one of the methods as described in the first aspect.

According to a seventh aspect of the present application, an authentication device, comprising:

a processor; and

a memory for storing instructions that are executable by the processor to perform any one of the methods of Portal authentication as described in the second aspect;

According to an eighth aspect of the present application, a computer-readable storage medium on which computer instructions are stored is provided, wherein the instructions are executed by a processor to implement steps of any one of the methods as described in the second aspect.

As can be seen from the technical solutions, in the present application, the Portal server authenticates login information returned by the user terminal through an authentication webpage in response to an authentication request from the user terminal, without authenticating login information of the user by the authentication device, thereby increasing flexibility of the authentication device.

### BRIEF DESCRIPTION OF DRAWINGS

FIG. 1 is a diagram of an application scenario of Portal authentication according to an exemplary embodiment of the present application;

FIG. 2 is a flowchart of a method for Portal authentication based on a Portal server according to an exemplary embodiment of the present application;

FIG. 3 is a flowchart of a method for Portal authentication based on an authentication device according to an exemplary embodiment of the present application;

FIG. 4 is a flowchart of a method for Portal authentication according to an exemplary embodiment of the present application;

FIG. 5 is a flowchart of a verification method for authentication device according to an exemplary embodiment of the present application;

FIG. 6 is a schematic structural diagram of an electronic device based on a Portal server according to an exemplary embodiment of the present application;

FIG. 7 is a block diagram of a device for Portal authentication based on a Portal server according to an exemplary embodiment of the present application;

FIG. 8 is a schematic structural diagram of an electronic device based on an authentication device according to an exemplary embodiment of the present application; and

FIG. 9 is a block diagram of a device for Portal authentication based on an authentication device according to an exemplary embodiment of the present application.

### DETAILED DESCRIPTION

Examples will be described in detail herein with the examples thereof expressed in the drawings. When the following descriptions involve the drawings, like numerals in different drawings represent like or similar elements unless stated otherwise. The implementations described in the following examples do not represent all implementations consistent with the present disclosure. On the contrary, they are merely examples of an apparatus and a method consistent with some aspects of the present disclosure described in detail in the appended claims.

The terms used in the present disclosure are for the purpose of describing a particular example only, and are not intended to limit the present disclosure. The singular forms such as “a,” ‘said,” and “the” used in the present disclosure and the appended claims are also intended to include multiple, unless the context clearly indicates otherwise. It is also to be understood that the term “and/or” as used herein refers to any or all possible combinations that include one or more associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “in response to determining”.

Portal access authentication, also referred to Web (webpage) authentication, is an authentication method in the process of Internet access. In the related art, when a user accesses network resources and an authentication device determines that the user's online state is not online, the user is pushed a Portal authentication address by the authentication device to obtain a login page from a Portal server through the Portal authentication address. Therefore, an authentication request generated after the user input correct login information into a login page can pass the authentication of the authentication device, and then the user can normally access network resources.

FIG. 1 is a diagram of an application scenario of Portal authentication according to an exemplary embodiment of the present application. As shown in FIG. 1, the authentication device serves as a connection device between a user terminal and a Portal server, which may be a router or a switch. The authentication device is connected to a network server representing Internet, so that network resources accessed by the user are provided by the network server, and the authentication device sends the network resources to the user terminal after verifying their authority, wherein a type of connection between the user and the network server can be Client/Server Model, C/S Model, and Browser/Server Model, B/S Model, when a type of connection is C/S Mode, the client can be an Internet TV terminal, a laptop, a tablet, a mobile phone, etc.

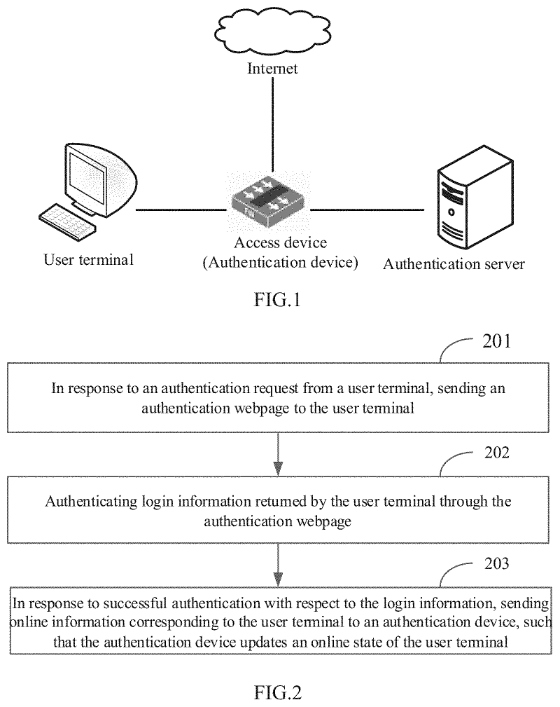

Referring to FIG. 2, FIG. 2 is a flowchart of a method for Portal authentication based on a Portal server according to an exemplary embodiment of the present application. As shown in FIG. 2, the Portal server may perform the following steps: in response to an authentication request from a user terminal, sending an authentication webpage to the user terminal (Step 201); authenticating login information returned by the user terminal through the authentication webpage (Step 202); and in response to successful authentication with respect to the login information, sending online information corresponding to the user terminal to an authentication device, such that the authentication device updates an online state of the user terminal (Step 203).

In an embodiment, in response to successful authentication with respect to the login information, the Portal server may sign the online information with a key shared by the Portal server and the authentication device to obtain signed information, and send the signed information to the authentication device, so that the authentication device verifies the received online information, which may implement security verification of the received online information by the authentication device and avoid an attack by a fake online packet.

In an embodiment, in response to a successful authentication with respect to the login information, the Portal server may obtain a creation timestamp of the online information, and send the creation timestamp to the authentication device, so that the authentication device may verify the online information based on time difference between a time of receiving the online information and the creation timestamp. In the case where an attacker intercepts and retransmits a packet received by the authentication device to perform a replay attack, the authentication device can obtain a timestamp of the received packet and determine whether or not the packet originates from the attacker by determining whether or not difference between a time of receiving the packet and a timestamp of the packet is within a pre-set threshold, so that even if the attacker can intercept the packet containing the signed information generated by the correct key, due to time consumption in the process of interception and retransmission, the time of receiving the packet by the authentication device inevitably delays compared to the time when normally receiving a packet by the authentication device, and the verification rules of the authentication device for a timestamp of a packet cannot be met, so that the authentication device can identify the packet sent due to the replay attack, thereby improving accuracy in identifying the attack packet and security of the system.

In the above embodiments, the Portal server authenticates login information input by the user on an authentication webpage, and in response to successful authentication of the login information, sends online information corresponding to the user to the authentication device, and the authentication device updates online state of the user terminal, which differs from a process for authenticating user information by an authentication device in the relevant art in that the Portal server does not need to further forward the login information to the authentication device for login authentication, nor does the authentication device perform an authentication matching process of the login information, thereby not only simplifying steps of the login authentication but also improving flexibility of the authentication device.

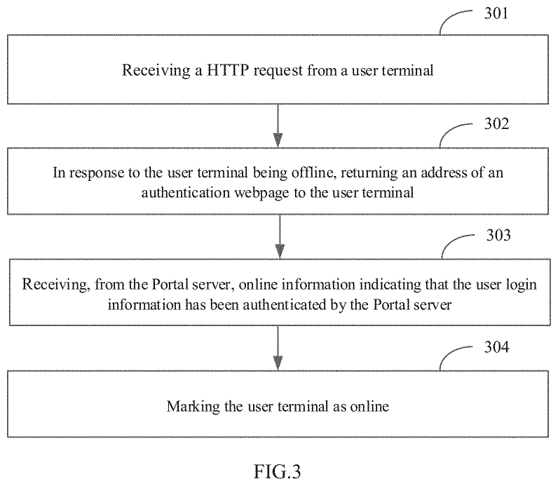

Referring to FIG. 3, FIG. 3 is a flowchart of a method for Portal authentication based on an authentication device according to an exemplary embodiment of the present application. As shown in FIG. 3, the authentication device performs the following steps: receiving a HTTP (HyperText Transfer Protocol) request from a user terminal (Step 301); in response to the user terminal being offline, returning an address of an authentication webpage to the user terminal, such that the user terminal sends user login information to a Portal server by accessing the address (Step 302); receiving, from the Portal server, online information indicating that the user login information has been authenticated by the Portal server (Step 303); and marking the user terminal as online (Step 304).

In an embodiment, the authentication device may further receive the signed information from the Portal server, which is obtained by signing the online information with a key shared by the Portal server and the authentication device. The authentication device may sign the online information with the shared key to obtain signed verification information at the authentication device, and may determine whether or not the signed information is consistent with the signed verification information. If the signed information is consistent with the signed verification information, the authentication device may determine that the online information is verified, and then mark the user terminal corresponding to the verified online information as online. With verification of the online information by the authentication device, interference with a normal login behavior by a fake login behavior of an attacking device can be avoided, thereby strengthening isolation between the internal and the external and improving security of Portal authentication.

In another embodiment, the authentication device may further receive a creation timestamp of the online information from the Portal server. The authentication device may determine time difference between a time of receiving the online information and the creation timestamp, and determine whether or not the time difference is less than a preset threshold. If the time difference is less than the preset threshold, the authentication device may determine that the online information has been verified. In the case where an attacker intercepts and re-sends a packet received by the authentication device to perform a replay attack, the authentication device can obtain a timestamp of the received packet, and determine whether or not difference between a time of receiving the packet and a timestamp of the received packet is within a preset threshold so as to determines whether or not the packet originates from the attacker. Thus, even if the attacker can intercept a packet containing the signed information generated by the correct key, the time of receiving the packet by the authentication device inevitably delays with respect to the time of normally receiving a packet by the authentication device due to time spent in the process of interception and retransmission, and the verification rule of the authentication device for a timestamp of a packet cannot be met. Therefore, the authentication device can identify a packet sent for the replay attack, thereby improving accuracy in identifying the attack packet and security of the system.

In the above embodiment, the authentication device determines an online state of a user terminal, and returns the address of the authentication webpage to an offline user terminal, so that the user terminal can send user login information to the Portal server by accessing the address, thereby controlling authority of the user terminal to access network resources In addition, the authentication device further verifies the online information authenticated by the Portal server, and marks the online state of a user terminal corresponding to the verified online information as online and the online state of a user terminal corresponding to the unverified online information as offline, thereby avoiding interference with a normal login behavior by a fake login behavior of an attacking device and improving security of Portal authentication.

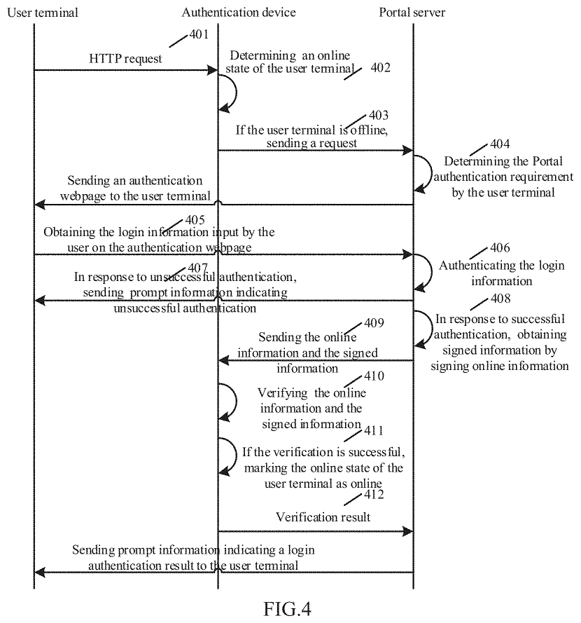

An interaction process of the method for Portal authentication according to an exemplary embodiment of the present application will be described below with reference to FIG. 4. As shown in FIG. 4, the method comprises Steps 401-412.

In Step 401, an authentication device receives a HTTP request from a user terminal.

In Step 402, the authentication device determines an online state of the user terminal.

In Step 403, if the user terminal is offline, the authentication device sends, to a Portal server, a request related to Portal authentication requirement by the user terminal.

The authentication device can send the request related to Portal authentication requirement by the user terminal to the Portal server in any one of the following modes.

Mode 1: if the HTTP request sent by the user terminal is a request for a webpage related to Portal authentication, the authentication device directly forwards the request to the Portal server, so that the Portal server sends an authentication webpage to the user terminal.

In this mode, the user terminal can actively issue a request for accessing a known Portal authentication webpage, so that the user can directly input login information on the requested Portal authentication webpage, thereby improving efficiency in determining the authentication requirement by the user terminal.

Mode 2: based on a behavior of the user terminal accessing any third-party webpage, the authentication device pushes an address for Portal authentication to the user terminal, so that the request of the user terminal based on the address of Portal authentication is sent to the Portal server.

In this mode, based on the behavior of the user terminal accessing any third-party webpage, the authentication device pushes the address for Portal authentication to the user terminal, so that the user terminal issues a request for obtaining a Portal authentication webpage to the Portal server through the address for the Portal authentication. Then, the Portal server determines the Portal authentication requirement by the user terminal and sends the Portal authentication webpage to the user terminal.

Mode 3: the authentication device directly modifies the webpage address accessed by the user terminal to the address of the Portal authentication webpage, and forwards the modified request to the Portal server.

In this mode, upon determining that the user terminal is off-line, the authentication device directly modifies the webpage address accessed by the user terminal to the address of the Portal authentication webpage and forwards the modified request to the Portal server. Thus, the Portal server determines, based on the request for obtaining the Portal authentication webpage and characteristic information of the user, that there is a user terminal having Portal authentication requirement, and sends the Portal authentication webpage to the user terminal.

Mode 4: the authentication device sends a state response code to a user terminal, so that the user terminal automatically generates, based on the state response code, a request with a destination address set as the address of the Portal server and sends the request to the Portal server.

In this mode, upon determining that the user terminal is offline, the authentication device may send the state response code to the user terminal, so that the user terminal automatically generates, based on the state response code, the request with the destination address set as the address of the Portal server and sends the request to the Portal server. Thus, the Portal server determines that there is a user terminal having Portal authentication requirement, and sends the Portal authentication webpage to the user terminal.

In Step 404, upon determining the Portal authentication requirement by the user terminal, the Portal server sends an authentication webpage to the user terminal.

In an embodiment, the user terminal may actively issue a request for Portal authentication, such as a request for accessing a known Portal authentication webpage, so that the Portal server determines the Portal authentication requirement by the user terminal and sends an authentication webpage to the user terminal. Thus, the user can directly input the login information on the requested Portal authentication webpage, thereby improving efficiency in determining the authentication requirement by the user terminal.

In another embodiment, based on the behavior of the user terminal accessing any third-party webpage, the authentication device determines the online state of the user terminal and, upon determining that the user terminal is offline, pushes the address for Portal authentication to the user terminal, so that the user terminal issues the request for obtaining a Portal authentication webpage to the Portal server through the address for Portal authentication. Then, the Portal server determines the Portal authentication requirement by the user terminal and sends the Portal authentication webpage to the user terminal.

In further another embodiment, upon determining that the user terminal is off-line, the authentication device directly modifies the webpage address accessed by the user terminal to the address of the Portal authentication webpage and forwards the modified request to the Portal server. Thus, the Portal server determines, based on the request for obtaining the Portal authentication webpage and characteristic information of the user, that there is a user terminal having Portal authentication requirement, and sends the Portal authentication webpage to the user terminal.

In yet another embodiment, upon determining that the user terminal is offline, the authentication device may send the state response code to the user terminal, so that the user terminal automatically generates, based on the state response code, the request with the destination address set as the address of the Portal server and sends the request to the Portal server. Thus, the Portal server determines that there is a user terminal having Portal authentication requirement, and sends the Portal authentication webpage to the user terminal.

In Step 405, the Portal server obtains the login information input by the user on the authentication webpage.

In this embodiment, the login information may be a combination of an account number and a password, or a picture or an image which is pre-stored or obtained in real time, or voice information or video information which is pre-stored or obtained in real time.

In Step 406, the Portal server authenticates the login information input by the user on the authentication webpage.

In this embodiment, the Portal server authenticates the login information input by the user on the authentication webpage to determine whether or not the user has access rights. This differs from a process for authenticating user information by an authentication device in the relevant art in: the Portal server does not need to further forward the login information to the authentication device for login authentication, and the authentication device does not need to perform an authentication matching process on the login information. Therefore, the process of the login authentication is simplified and flexibility of the authentication device is improved.

In Step 407, in response to unsuccessful authentication, the Portal server returns, to the user terminal, prompt information indicating unsuccessful authentication.

In Step 408, in response to successful authentication, the Portal server obtains signed information by signing online information corresponding to the login information based on a key.

In this embodiment, the Portal server obtains the online information of the user from the login information. The online information may include, for example, a user name, an IP address of the user terminal, an identifier of a group to which the user belongs, and a timestamp of the current system, and the like. Furthermore, the obtained online information is signed to obtain signed information. In a specific embodiment, a signing process may be an MD5 encryption process. Since MD5 is an irreversible encryption algorithm, it is difficult to extrapolate a plaintext (an unencrypted string) from an MD5-encrypted ciphertext (an encrypted string). For example, MD5 (“abc”) 900150983cd24fb0d6963f7d28e17f72, that is, the ciphertext “900150983cd24fb0d6963f7d28e17f72” can be easily calculated from “abc”, but it is difficult to calculate the plaintext “abc” from the ciphertext “900150983cd24fb0d6963f7d28017f72”, Thus, even if the signed information and the online information are obtained, the key cannot be extrapolated, thereby ensuring confidentiality and reliability of encrypting the online information by the Portal server.

In a specific signing process, the user name, the IP address of the user terminal, the identifier of the group to which the user belongs and the timestamp included in the online information and a shared key may be concatenated to obtain information to be encrypted.

For example, if the user name is “test”, the IP address of the user terminal is “192.168.0.1”, the identifier of the group to which the user belongs is “Supper”, the timestamp is “1543459024”, and the shared key is “12345678”, the information obtained by the concatenation process is “test192.168.0.1Supper154345902412345678”. Accordingly, the MD5 encryption process can be expressed as: MD5 (“test192.168.0.1Supper154345902412345678”), and the following signed information can be obtained after the signing process: sign=85b3225907f79629ac1b2f9e7e2215ac.

In Step 409, the Portal server sends the online information and the signed information to the authentication device for verification.

In Step 410, the authentication device verifies the received online information and signed information.

Referring to FIG. 5, a process of verifying; by the authentication device, the received online information and signed information is shown. FIG. 5 is a flowchart of a verification method by an authentication device according to an exemplary embodiment of the present application. As shown in FIG. 5, the authentication device can perform Steps 501-504.

In Step 501, the authentication device determines whether or not the timestamp in the online information is consistent with local time. If the timestamp in the online information is not consistent with the local time, the process proceeds to step 502; otherwise, the process proceeds to step 503.

In an embodiment, it can be determined whether or not the timestamp in the online information is the same as the local time. If the timestamp in the online information is the same as the local time, it may be determined that the time stamp in the online information is consistent with the local rime; otherwise, it may be determined that the time stamp in the online information is inconsistent with the local time.

In another embodiment, it can be determined whether or not difference between the timestamp in the online information and the local rime is less than a preset threshold. If the difference between the timestamp in the online information and the local time is less than the preset threshold, it may be determined that the timestamp in the online information is consistent with the local time; otherwise, it may be determined that the time stamp in the online information is inconsistent with the local time.

In Step 502, the authentication device refuses to update the online state of the user terminal corresponding to the online information.

In this embodiment, since an default online state of the user terminal is “offline”, refusal to update the online state of the user terminal corresponding to the online information is to keep the online state of the user terminal corresponding to the online information as offline.

In Step 503, the authentication device obtains signed verification information by encrypting the online information based on the stored key.

According to an embodiment, in a specific signing process, the user name, the IP address of the user terminal, the identifier of the group to which the user belongs and the timestamp included in the online information and a shared key may be concatenated to obtain information to be encrypted. The signing process can be an MD5 encryption process. Since MD5 is an irreversible encryption algorithm, it is difficult to extrapolate a plaintext (an unencrypted string) from a MD5-encrypted ciphertext (an encrypted string), Thus, even if the signed information and the online information are obtained, the key cannot be extrapolated, thereby ensuring confidentiality and reliability of the encryption process.

In Step 504, the authentication device verifies whether or not the signed verification information is consistent with the received signed information. If the signed verification information is consistent with the received signed information, the verification is successful; otherwise, the verification is unsuccessful, and the process proceeds to step 502.

In Step 411, if the verification is successful, the authentication device marks the online state of the user terminal corresponding to the online information as online.

In Step 412, the authentication device sends the verification result to the Portal server, so that the Portal server feeds back prompt information, indicating a login authentication result, to the user terminal according to the verification result.

In this embodiment, if the verification result indicates successful verification, the authentication device sends a result of the successful verification to the Portal server, so that the Portal server feeds back prompt information, indicating successful login authentication, to the user terminal. If the verification result indicates unsuccessful verification, the authentication device sends a result of the unsuccessful verification to the Portal server, so that the Portal server feeds back prompt information, indicating unsuccessful login authentication, to the user terminal.

In the above embodiment, the Portal server authenticates the received user login information, signs the online information corresponding to the authenticated login information, sends the online information and the signed information obtained by encryption to the authentication device for verification, and sends prompt information indicating successful login authentication only to the user terminal corresponding to the verified online information, thereby improving security of login authentication.

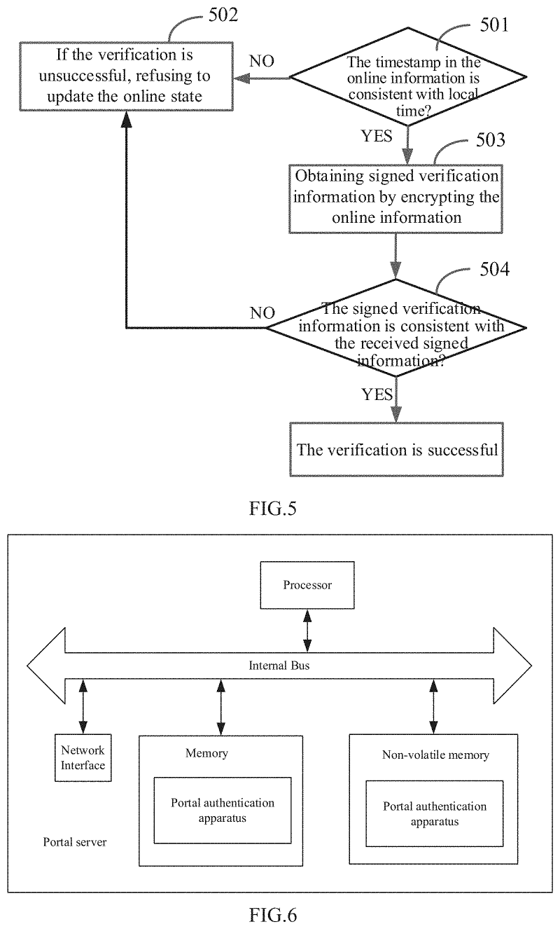

FIG. 6 is a schematic structural diagram of an electronic device based on a Portal server according to an exemplary embodiment of the present application. Referring to FIG. 6, at a hardware level, the electronic device includes a processor, an internal bus, a network interface, a memory, and a non-volatile memory. Of course, it may further include hardware required for other services. The processor reads the corresponding computer program from the non-volatile memory into the memory and runs it to form a Portal authentication apparatus at a logical level. Of course, in addition to software implementations, this application does not exclude other implementations, such as a logic device or a combination of software and hardware, etc., that is to say, execution bodies of the following processing flows are not limited to each of the logical units, but can also be hardware or logic devices.

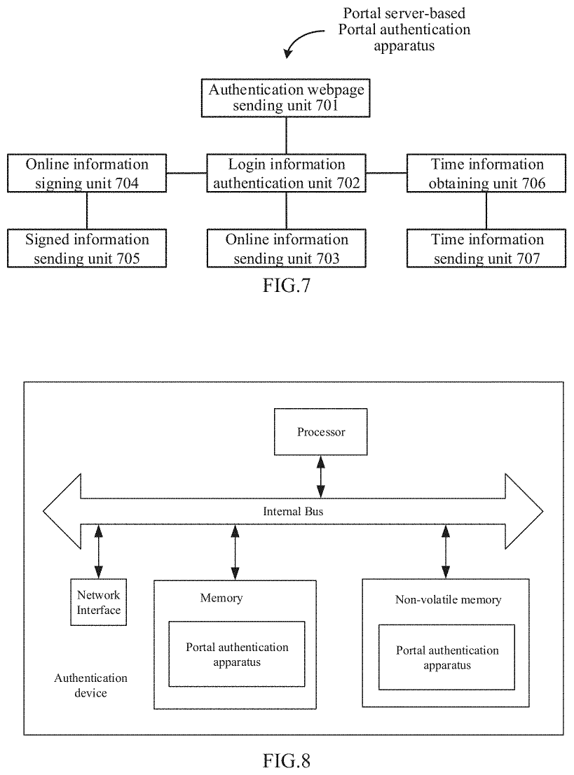

Referring to FIG. 7, which is a block diagram of a Portal server-based Portal authentication apparatus according to an exemplary embodiment of the present application. As shown in FIG. 7, in a software implementation, the Portal server-based Portal authentication apparatus can include:

an authentication webpage sending unit 701, configured to in response to an authentication request from a user terminal, send an authentication webpage to the user terminal;

a login information authentication unit 702, configured to authenticate login information returned by the user terminal through the authentication webpage; and

an online information sending unit 703, configured to in response to successful authentication with respect to the login information, send online information corresponding to the user terminal to an authentication device, such that the authentication device updates an online state of the user terminal.

Alternatively, the device further comprises:

an online information signing unit 704, configured to in response to the successful authentication with respect to the login information, sign the online information with a key shared by the Portal server and the authentication device to obtain signed information; and

a signed information sending unit 705, configured to send the signed information to the authentication device, such that the authentication device verifies the online information.

Alternatively, the device further comprises:

a time information obtaining unit 706, configured to in response to the successful authentication with respect to the login information, obtaining a creation timestamp of the online information;

a time information sending unit 707, configured to send the creation timestamp to the authentication device, such that the authentication device verifies the online information based on time difference between a time of receiving the online information and the creation timestamp.

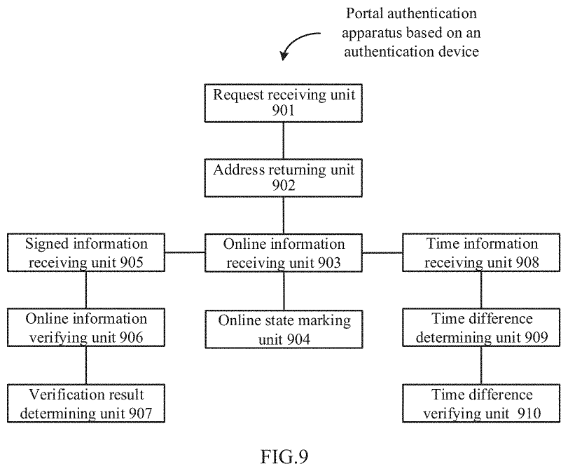

FIG. 8 is a schematic structural diagram of an electronic device based on an authentication device according to an exemplary embodiment of the present application. Referring to FIG. 8, at a hardware level, the electronic device includes a processor, an internal bus, a network interface, a memory, and a non-volatile memory. Of course, it may further include hardware required for other services. The processor reads the corresponding computer program from the non-volatile memory into the memory and runs it to form a Portal authentication apparatus at a logical level. Of course, in addition to the software implementations, this application does not exclude other implementations, such as a logic device or a combination of software and hardware, etc., that is to say, execution bodies of the following processing flows are not limited to each of the logical units, but can also be hardware or logic devices.

Referring to FIG. 9, which is a block diagram of a Portal authentication apparatus based on an authentication device according to an exemplary embodiment of the present application. As shown in FIG. 9, in a software implementation, the Portal authentication apparatus based on the authentication device may include:

a request receiving unit 901, configured to receive a Hyper Text Transfer Protocol (HTTP) request from a user terminal;

an address returning unit 902, configured to in response to determining that the user terminal is not online, return an address of an authentication webpage to the user terminal, such that the user terminal sends user login information to a Portal server by accessing the address;

an online information receiving unit 903, configured to receive online information from the Portal server, wherein the online information indicating that the user login information is authenticated by the Portal server; and

an online state marking unit 904, configured to mark the user terminal as online.

Alternatively, the apparatus further comprises:

a signed information receiving unit 905, configured to receive signed information from the Portal server, wherein the signed information is obtained by signing the online information with a key shared by the Portal server and the authentication device;

an online information verifying unit 906, configured to sign the online information with the shared key to obtain signed verification information at the authentication device;

a verification result determining unit 907, configured to in response to determining that the signed information is consistent with the signed verification information, determine that the online information is verified, wherein the marking of the user terminal as online comprises: marking the user terminal corresponding to the verified online information as online.

Alternatively, the online information verifying unit 906, further configured to in response to determining that a timestamp in the online information is consistent with local time, sign the online information with the shared key.

Alternatively, the apparatus further comprises:

a time information receiving unit 908, configured to receive a creation timestamp of the online information from the Portal server;

a time difference determining unit 909, configured to determine time difference between a time of receiving the online information and the creation timestamp; and

a time difference verifying unit 910, configured to in response to that the time difference is less than a preset threshold, determine that the online information is verified, wherein the marking of the user terminal as online comprises: marking the user terminal corresponding to the verified online information as online.

The device corresponds to the above method, and the same details will not be described one by one.

In a typical configuration, a computing device includes one or more processors (CPUs), input/output interfaces, network interfaces, and a memory.

The memory may include a non-permanent memory, a random-access memory (RAM) and/or a non-volatile memory in computer-readable media, such as a read-only memory (ROM) or a flash memory (flash RAM). The memory is an example of computer-readable media.

A computer-readable media, including a permanent or non-permanent, and removable or non-removable media, can store information by means of any method or technology. The information may be computer readable instructions, data structures, modules of programs, or other data. Examples of a storage medium of a computer include, but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disk read-only memory (CD-ROM), a digital versatile disc (DVD) or other optical storage, a magnetic tape cassettes, a magnetic tape magnetic disk storage or other magnetic storage devices or any other non-transmission media, which can be used to store information that can be accessed by a computing device. As defined herein, a computer-readable medium does not include a transitory computer-readable medium, such as a modulated data signal and a carrier wave.

For the device example, since it basically corresponds to the method example, reference may be made to the partial description of the method example. The device examples described above are merely illustrative, wherein the modules/units described as separate components may or may not be physically separate, and the components displayed as modules/units may or may not be physical modules/units, that is, may be located at one place, or can be distributed to multiple network modules/units, Some or all the modules/units may be selected according to actual needs to achieve the objectives of the present disclosure. It can be understood and implemented by those of ordinary skill in the art without any creative effort.

Although the present description contains many specific implementation details, these should not be interpreted as limitation to a scope of the present disclosure, but are mainly used to describe features of specific embodiments of the present disclosure. Certain features described in several embodiments within this description can also be implemented in combination in a single embodiment. On the other hand, various features described in a single embodiment can also be implemented separately in several embodiments or implemented in any suitable sub-combination. Furthermore, although features can function in certain combinations as described above and even initially claimed as such, one or more features from the claimed combination can be removed from the combination in some cases and the claimed combinations can point to sub-combinations or variations of sub-combinations.

Some examples of the present disclosure are described above and are not intended to limit the disclosure. Any variations, equivalent replacements, modifications or the like within the spirit and principles of the present disclosure should fall within the scope of the present disclosure.

1. A method of Portal authentication, the method being applied to a Portal server and comprising:
in response to an authentication request from a user terminal, sending an authentication webpage to the user terminal;
authenticating login information returned by the user terminal through the authentication webpage; and
in response to successful authentication with respect to the login information, sending online information corresponding to the user terminal to an authentication device, such that the authentication device updates an online state of the user terminal.

2. The method of claim 1, further comprising:
in response to the successful authentication with respect to the login information, signing the online information with a key shared by the Portal server and the authentication device to obtain signed information; and
sending the signed information to the authentication device, such that the authentication device verifies the online information.

3. The method of claim 1, further comprising:
in response to the successful authentication with respect to the login information, obtaining a creation timestamp of the online information; and
sending the creation timestamp to the authentication device, such that the authentication device verifies the online information based on time difference between a time of receiving the online information and the creation timestamp.

4. A method of Portal authentication, the method being applied to an authentication device and comprising:
receiving a Hyper Text Transfer Protocol (HTTP) request from a user terminal;
in response to determining that the user terminal is not online, returning an address of an authentication webpage to the user terminal, such that the user terminal sends user login information to a Portal server by accessing the address; and
upon receiving, from the Portal server, online information indicating that the user login information is authenticated by the Portal server, marking the user terminal as online.

5. The method according to claim 4, further comprising:
receiving signed information from the Portal server, wherein the signed information is obtained by signing the online information with a key shared by the Portal server and the authentication device;
signing the online information with the shared key to obtain signed verification information at the authentication device; and
in response to determining that the signed information is consistent with the signed verification information, determining that the online information is verified,
wherein the marking of the user terminal as online comprises: marking the user terminal corresponding to the verified online information as online.

6. The method according to claim 5, wherein the signing of the online information with the shared key comprises:
in response to determining that a timestamp in the online information is consistent with local time, signing the online information with the shared key.

7. The method according to claim 4, further comprising:
receiving a creation timestamp of the online information from the Portal server; and
in response to determining that time difference between a time of receiving the online information and the creation timestamp is less than a preset threshold, determining that the online information is verified,
wherein the marking of the user terminal as online comprises: marking the user terminal corresponding to the verified online information as online.

8. A Portal server, comprising:
a processor; and
a memory for storing instructions that are executable by the processor to perform operations comprising:
in response to an authentication request from a user terminal, sending an authentication webpage to the user terminal;
authenticating login information returned by the user terminal through the authentication webpage; and
in response to successful authentication with respect to the login information, sending online information corresponding to the user terminal to an authentication device, such that the authentication device updates an online state of the user terminal.

9. The Portal server of claim 8, wherein the operations further comprise:
in response to the successful authentication with respect to the login information, signing the online information with a key shared by the Portal server and the authentication device to obtain signed information; and
sending the signed information to the authentication device, such that the authentication device verifies the online information.

10. The Portal server of claim 8, wherein the operations further comprise:
in response to the successful authentication with respect to the login information, obtaining a creation timestamp of the online information; and
sending the creation timestamp to the authentication device, such that the authentication device verifies the online information based on time difference between a time of receiving the online information and the creation timestamp.

11. An authentication device, comprising:
a processor; and
a memory for storing instructions that are executable by the processor to perform the method of Portal authentication according to claim 4.

12. The authentication device according to claim 11, wherein the processor is further configured to perform operations comprising:
receiving signed information from the Portal server, wherein the signed information is obtained by signing the online information with a key shared by the Portal server and the authentication device;
signing the online information with the shared key to obtain signed verification information; and
in response to determining that the signed information is consistent with the signed verification information, determining that the online information verified, and
wherein the marking of the user terminal as online comprises: marking the user terminal corresponding to the verified online information as online.

13. The authentication device according to claim 12, wherein the signing of the online information with the shared key comprises:
in response to determining that a timestamp in the online information is consistent with local time, signing the online information with the shared key.

14. The authentication device according to claim 11, wherein the processor is further configured to perform operations comprising:
receiving a creation timestamp of the online information from the Portal server; and
in response to determining that time difference between a time of receiving the online information and the creation timestamp is less than a preset threshold, determining that the online information is verified, and
wherein the marking of the user terminal as online comprises: marking the user terminal corresponding to the verified online information as online.

15. A computer-readable storage medium having computer instructions stored thereon, wherein the instructions are executed by a processor to perform the method of Portal authentication according to claim 1.

16. A computer-readable storage medium having computer instructions stored thereon, wherein the instructions are executed by a processor to perform the method of Portal authentication according to claim 4.
